(19) United States
(12) Patent Application Publication
(10) Pub. No.: US 2026/0336901 A1
(43) Pub. Date: Oct. 29, 2026

(54) BULKHEAD SYSTEM FOR SECURING MATERIALS IN SHIPPING CONTAINER

(71) Applicant: Kodiak LLC, Chicago, IL (US)

(72) Inventors: Sheyanne Mooter, Chicago, IL (US); Ed Vogel, Ferndale, MI (US)

(21) Appl. No.: 19/191,759

(22) Filed: Apr. 28, 2025

(51) Int. Cl. B65D 81/05

(52) U.S. Cl. CPC B65D 81/053

(57) ABSTRACT

A bulkhead system for securing materials in a shipping container includes a bulkhead assembly of a sheet of material having a plurality of panels, wherein each panel includes a plurality of folding panels, at least one locking assembly to lock the folding panels together, wherein the at least one locking assembly includes a flap and a locking tab to lock a first folding panel and a second folding panel of the folding panels together, and wherein the flap is flipped up so that the first folding panel fits into the locking tab and the locking tab and the flap secures the first folding panel and the second folding panel together.

### BACKGROUND OF THE INVENTION

### 1. Technical Field

The present invention relates generally to shipping containers and, more specifically to, a bulkhead system for securing materials in a shipping container.

### 2. Description of Related Art

Shipping containers, also known as International Organization for Standardization (ISO) or intermodal containers, are used to receive, store, and transport a variety of materials, for example dry bulk cargo, around the world. When transporting dry bulk cargo, such as grains and milled products, bulkheads may be used to retain the material during loading, transport, and inspection. Multiple methods exist for enclosing, retaining, and sealing such materials or dry cargo in the shipping container for transport. For example, liners may be used to contain the materials or wood planks or 2×4's may be used at the end of the shipping container to contain the materials. In order to contain the materials or dry bulk cargo in the shipping container and prevent the materials from spilling out of the shipping container, a bulkhead may be placed across the back of the shipping container, creating space between the bulkhead and a front wall of the shipping container.

As shown in FIGS. 1 and 2, a conventional bulkhead 1 includes a plurality of sides 2 including one angled top and a bottom flap with another flap which is glued to create a foot. In order to assemble the bulkhead 1, the sides 2 must be a solid score cut where the scored bottom flap is cut straight which doesn't allow the bulkhead 1 to lock itself into the side walls of the shipping container. The width of the sides 2 on the bulkhead 1 is similar to a distance or width between the side walls of the shipping container and creates an inward projection 3. The bulkhead 1 includes an angled projection 4 on the ends of the sides 2. In addition, the bulkhead 1 includes straight ends 5 at the end of the sides.

One issue with conventional bulkheads is that they include gaps left between the bulkhead and side walls of the shipping container and gaps between the bulkhead and a bottom wall of the shipping container. Moreover, another issue with conventional bulkheads is that they are heavy and expensive to manufacture and may be used multiple times in order to recover the full value. Still another issue with conventional bulkheads is that the materials or dry bulk cargo must be deposited into the shipping container where something must be placed at the point of entry to prevent the materials from flowing outside of the shipping container.

The present invention is aimed at solving one or more of the issues identified above.

### SUMMARY OF THE INVENTION

The present invention provides a bulkhead system for a shipping container including a bulkhead assembly of a sheet of material having a plurality of panels, wherein each panel includes a plurality of folding panels, at least one locking assembly to lock the folding panels together, wherein the at least one locking assembly includes a flap and a locking tab to lock a first folding panel and a second folding panel of the folding panels together, and wherein the flap is flipped up so that the first folding panel fits into the locking tab and the locking tab and the flap secures the first folding panel and the second folding panel together.

One advantage of the present invention is that the bulkhead system provides an easy to assemble or fold forming bulkhead. Another advantage of the present invention is that the bulkhead system is able to lock into sides of any shipping container easily.

Other advantages of the present invention will be readily appreciated, as the same becomes better understood, by reference to the following detailed description when considered in connection with the accompanying drawings.

### BRIEF DESCRIPTION OF THE DRAWINGS

FIGS. 1 and 2 are perspective views of a conventional bulkhead.

FIG. 3 is a plan view of a bulkhead system, according to an embodiment of the present invention.

FIG. 4 is a front view of the bulkhead system of FIG. 3.

FIG. 5 is a partial side view of the bulkhead system of FIG. 3.

FIG. 6 is an end view of a second panel of the bulkhead system of FIG. 3.

FIG. 7 is an end view of the bulkhead system of FIG. 3.

FIG. 8 is a side view of the bulkhead system of FIG. 3 illustrated in an assembled position.

FIG. 9 is an interior view of a stacking assembly of the bulkhead system of FIG. 3.

FIGS. 10 and 11 are perspective views of the bulkhead system of FIG. 3 assembled and installed in a shipping container.

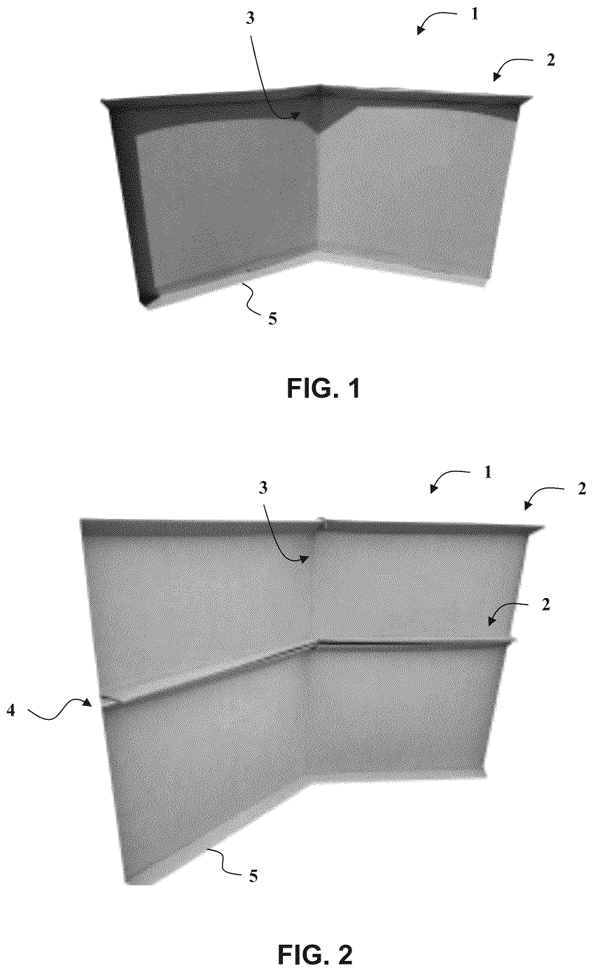

Corresponding reference numerals indicate corresponding components throughout the several views of the drawings.

### DETAILED DESCRIPTION OF THE INVENTION

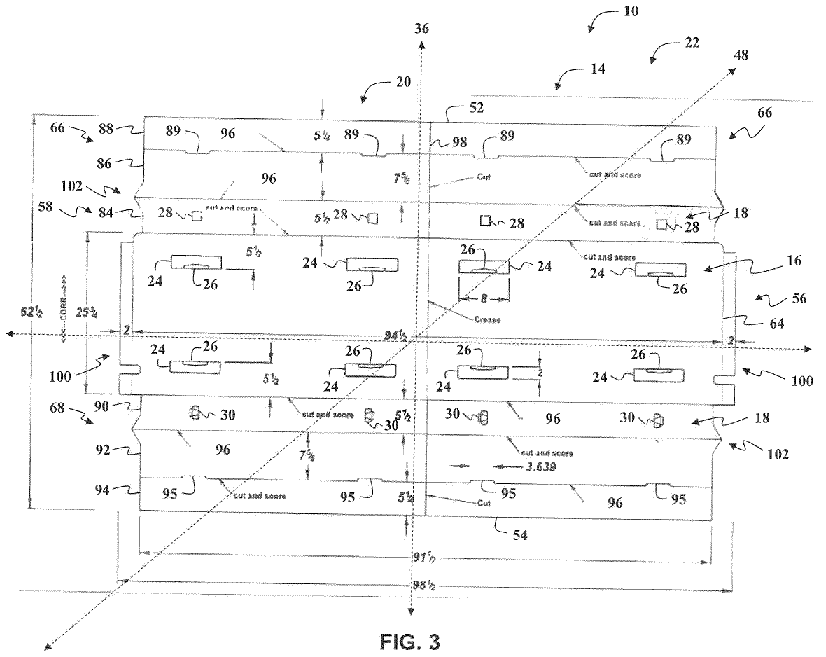

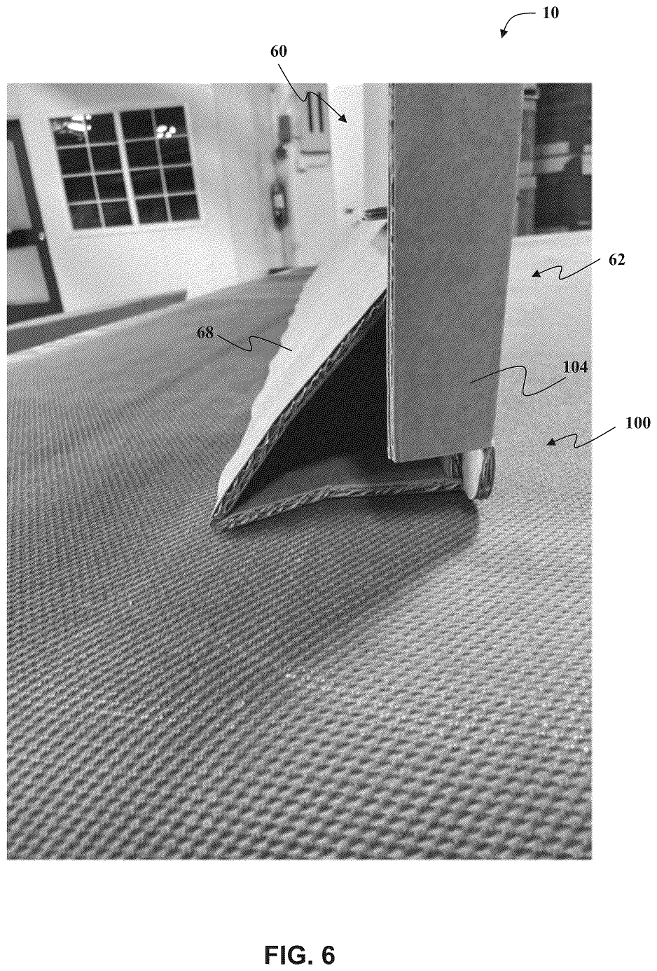

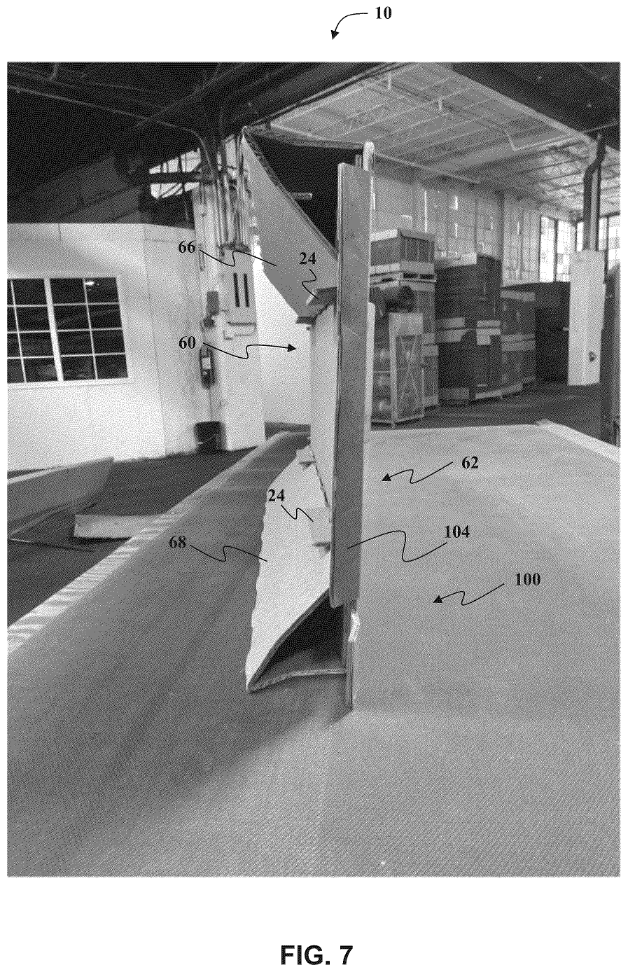

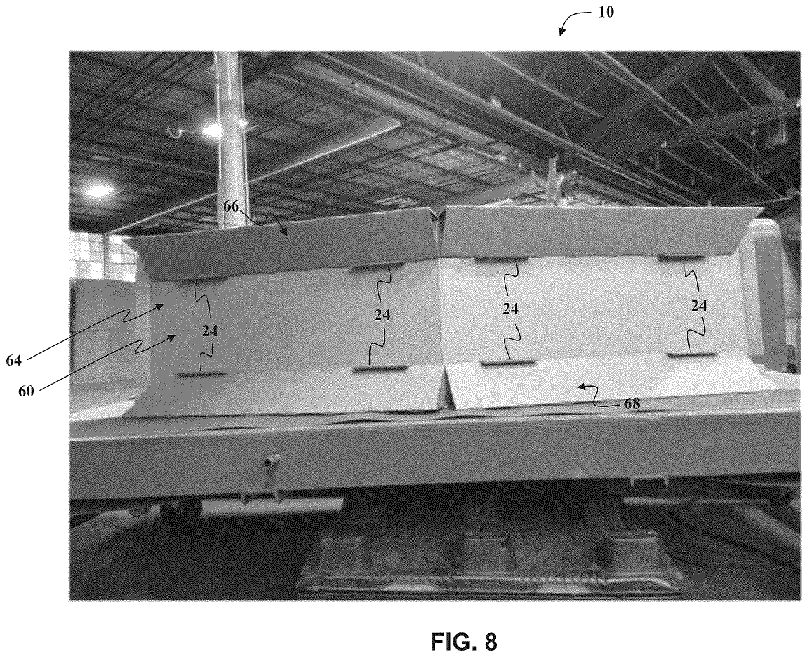

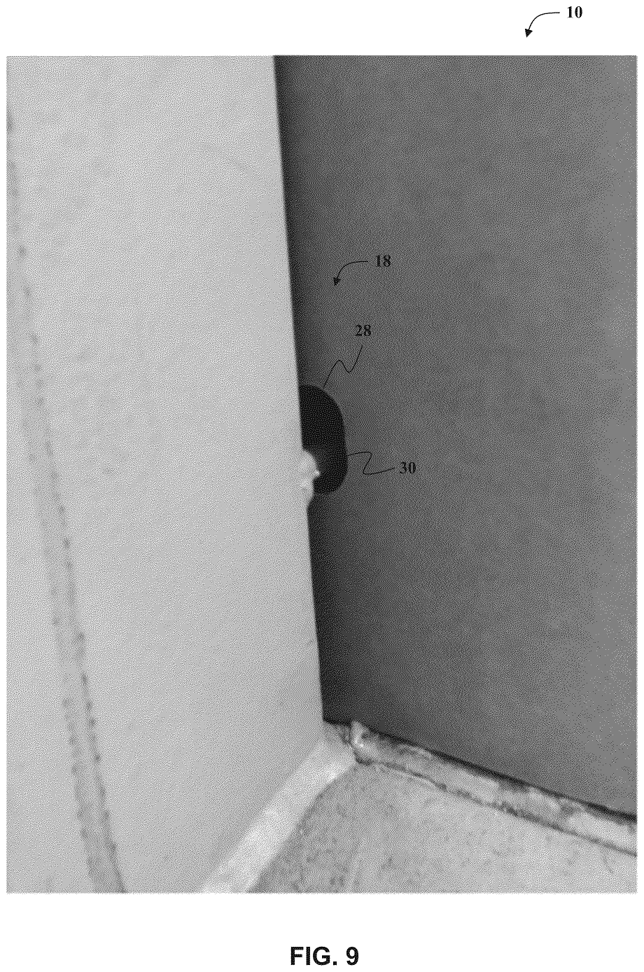

Referring to FIGS. 3-10, a bulkhead system 10, according to one embodiment of the present invention, is shown for securing materials in a shipping container 12. The bulkhead system 10 includes a bulkhead assembly 14, a locking assembly 16, and a stacking assembly 18. The bulkhead assembly 14 is assembled from a sheet of material 20. In one embodiment, the sheet of material 20 including a plurality of panels 22. The locking assembly 16 includes a flap 24 and a locking tab 26. The stacking assembly 18 includes an opening 28 and a stacking tab 30. It should be appreciated that each opening 28 is configured to receive at least one stacking tab 30.

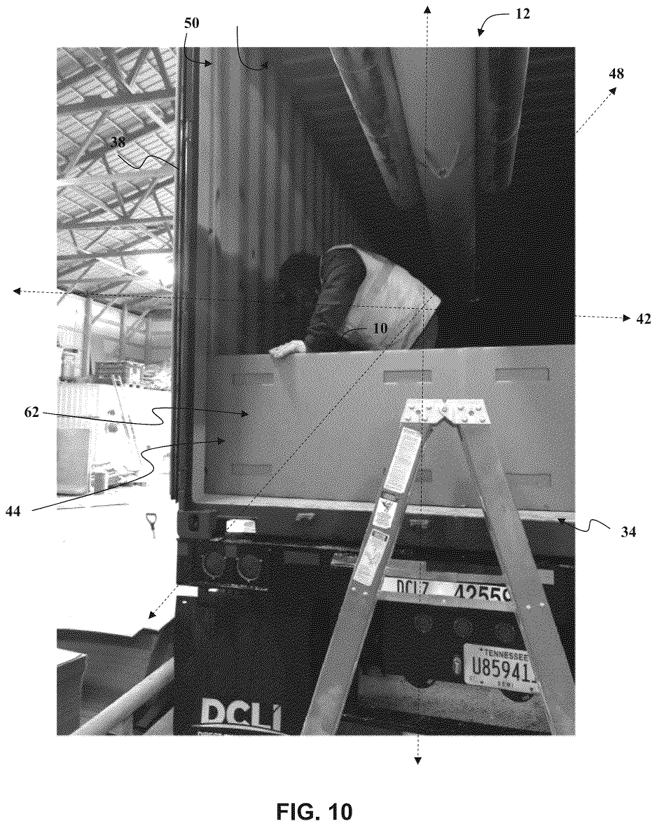

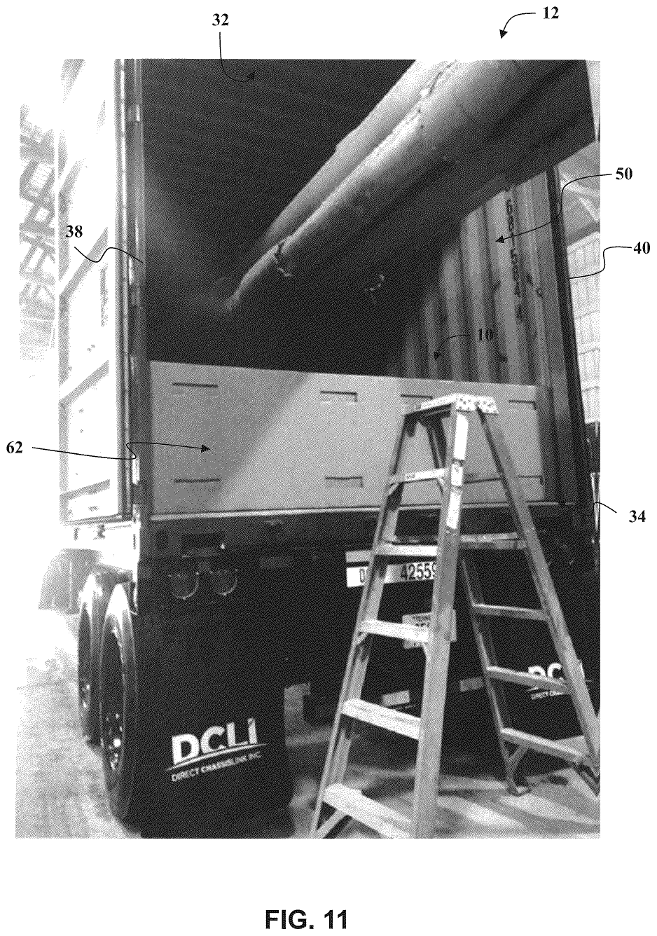

As illustrated in FIGS. 10 and 11, the shipping container 12 may have a top wall 32 and a bottom wall 34, where the bottom wall 34 is opposite the top wall 32 along a y-axis 36, a left side wall 38 and a right side wall 40, where the right side wall 40 is opposite the left side wall 38 along an x-axis 42, and a front and a back, where the back is opposite the front along a z-axis 48. The left side wall 38 and the right side wall 40 of the shipping container 12 include welded reinforcements creating a channel 50 on both side walls 38, 40. The channel 50 on both side walls 38, 40 of the shipping container 12 is configured to receive the bulkhead system 10. The front and back of the shipping container 12 may include doors creating an opening on the front and an opening on the back of the shipping container 12. It should be appreciated that the shipping container 12 may be made out of aluminum, steel, or a combination of these materials or other suitable materials.

Referring to FIG. 3, the bulkhead assembly 14 is assembled from the sheet of material 20. The sheet of material 20 is a thin, flexible, semi-rigid, substantially planar sheet. In one embodiment, the sheet of material 20 may be cardboard. In one embodiment, the sheet of material 20 may have a rectangular shape. In another embodiment, the sheet of material 20 may have an abnormal rectangular shape. Once folded or assembled, the bulkhead assembly 14 is configured to rest on the bottom wall 34 of the shipping container 12 in a close fit with the bottom wall 34. The bulkhead assembly 14 is configured to rest on the left side wall 38 and right side wall 40 of the shipping container 12 so that the bulkhead assembly 14 is flush with the channel 50 on either side wall 38, 40 of the shipping container 12. In another embodiment, the bulkhead assembly 14 fits into the channel 50 of the shipping container 12.

As illustrated in FIG. 3, the sheet of material 20 has a first side 52 and a second side 54. The second side 54 is opposite the first side 52 along the y-axis 36. The sheet of material 20 further includes a first transverse side 56 and a second transverse side 58. The first transverse side 56 is opposite the second transverse side 58 along the x-axis 42. The sheet of material 20 further includes a third side 60 and a fourth side 62, wherein the fourth side 62 is opposite the third side 60 along the z-axis 48.

Each of the panels 22 may include a center panel 64, a first panel 66, and a second panel 68. The center panel 64 includes a first edge and a second edge, where the second edge is opposite the first edge along the y-axis 36. The center panel 64 further includes a first transverse side and a second transverse side, where the first transverse side is opposite the second transverse side along the x-axis 42, and a first side and a second side, where the second side is opposite the first side along the z-axis 48. The first edge of the center panel 64 is coupled to the first panel 66 and the second edge of the center panel 64 is coupled to the second panel 68. Both the first panel 66 and the second panel 68 each include a plurality of folding panels, generally indicated at 82. In addition, both the first panel 66 and the second panel 68 include a first edge, a second edge, a first transverse side, a second transverse side, a first side and a second side.

In one embodiment, the first panel 66 includes a first folding panel 84, a second folding panel 86, and a third folding panel 88 which are designed to be rolled up or folded at an angle for additional beam strength. The third folding panel 88 includes a protruding tab 89 that is cut out of the second folding panel 86. The protruding tab 89 is configured to lock the first panel 66 into position once assembled. A cut out of the second folding panel 86 is configured to lock the first panel 66 into position by receiving the locking tab 26. The second panel 68 includes a first folding panel 90, a second folding panel 92, and a third folding panel 94 which are rolled up or folded at an angle for additional beam strength. The third folding panel 94 of the second panel 68 includes a protruding tab 95 that is cut out of the second folding panel 92. The protruding tab 95 is configured to lock the second panel 68 into position once assembled. The cut out of the second folding panel 92 is configured to lock the second panel 68 into position by receiving the locking tab 26.

Each of the panels 22 is foldably adjoined to an adjacent panel 22. In one embodiment, the panels 22 are foldably adjacent or coupled with a special cut/score 96 to reduce assembly implications. In addition, the center panel 64, first panel 66, and second panel 68 each have a cut 98 down the center of the panel 22. Once assembled, the cut 98 allows the bulkhead system 10 to help dissipate the pressure of the material being loaded and forcing the bulkhead system 10 to be tighter along the side walls 38, 40 of the shipping container 12.

As illustrated in FIGS. 3-8, the plurality of panels 22 may be folded on the cut/score design 96. This eases the assembly process by reducing a backlash memory affect from the heavy corrugated structure of the bulkhead system 10. The first panel 66 and the second panel 68 may be rolled up at a 90° to create a planar top and planar bottom. The angles are then projected to roll at 45°. It should be appreciated that the first panel 66 and the second panel 68 may be folded to strengthen the bulkhead system 10.

In one embodiment, the bulkhead system 10 includes a plurality of scored panels. The scored panels include at least one scored panel 100 on the center panel 64 and at least one scored panel 102 for the first panel 66 and the second panel 68. Each transverse side of the center panel 64 is coupled to the scored panel 100. Each scored panel 100 is scored with a cut out 101 to eliminate obstruction with welded reinforcements in the side walls 38, 40 of the shipping container 12. Once assembled and installed, the scored panel 100 fits flush within the channel 50 on the side walls 38, 40 of the shipping container 12.

In one embodiment, each side of the first panel 66 and each side of the second panel 68 are coupled to at least one scored panel 102. Each scored panel 102 is scored with a cut out to eliminate obstruction with welded reinforcements in the side walls 38, 40 of the shipping container 12 and is designed to fit a contour or the channel 50 of the side walls 38, 40 of the shipping container 12. As shown in FIGS. 3-8, the scored panels 100 of the center panel 64 are shaped to sit into the channel 50 of the side walls 38, 40 of the shipping container 12. In addition, the scored panels 102 of the first panel 66 and the second panel 68 are shaped to sit into the channel 50 of the side walls 38, 40 of the shipping container 12. In one embodiment, the scored panel 100 of the center panel 64 includes at least one tab 104 that may be folded to secure the bulkhead assembly 14 into the shipping container 12.

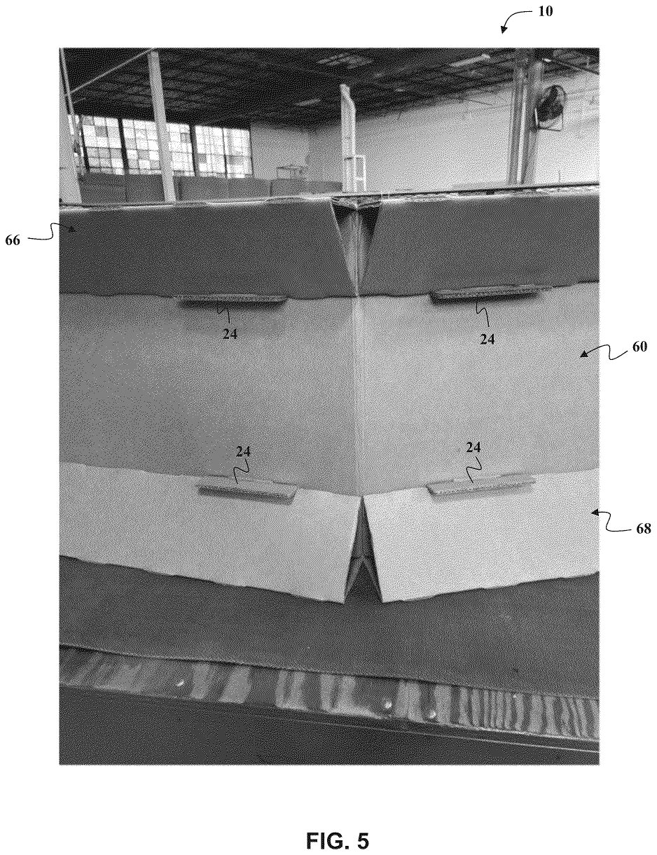

In order to achieve a side gripping feature, a length of the bulkhead system 10 is typically made slightly wider than a width of the shipping container 12. By making the bulkhead system 10 wider than the width of the shipping container 12, an inward projection or angle is created at the center of the bulkhead system 10, as illustrated in FIG. 5. This helps to dissipate the pressure of the material being loaded into the shipping container 12 and forcing the bulkhead system 10 to be tighter holding by the material inside the shipping container 12. The inward bend of the bulkhead system 10 may happen to the center panel 64, the first panel 66, and the second panel 68. Depending on the size of the shipping container 12, once the first panel 66 and the second panel 68 are assembled, the bulkhead system 10 may move inward or outward to create a tight holding fit with the side walls 38, 40 of the shipping container 12.

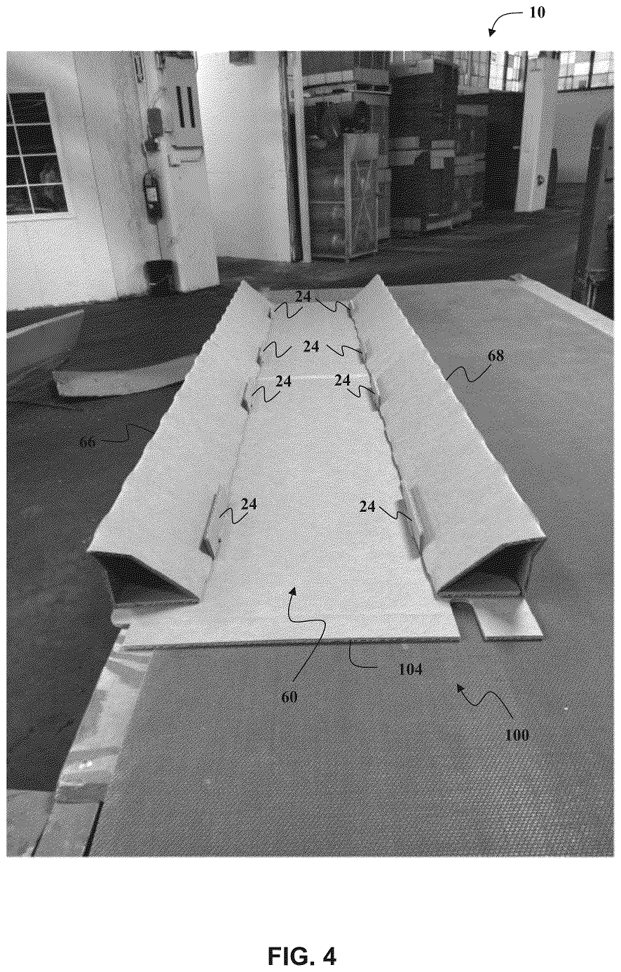

In one embodiment, the bulkhead system 10 includes a plurality of locking assemblies 16. Each locking assembly 16 includes the flip up flap 24 and the locking tab 26. The locking assembly 16 allows the first panel 66 and the second panel 68 to be assembled without creating an open hold in the center panel 64. As illustrated in FIG. 4, each locking assembly 16 receives the first panel 66 or the second panel 68 by flipping the flap 24 up and using the locking tab 26 to lock the first panel 66 or the second panel 68 into place. It should be appreciated that each locking assembly 16 secures the first panel 66 and the second panel 68 upon assembly of the bulkhead system 10.

In yet another embodiment, the bulkhead system 10 includes a plurality of stacking assemblies 18. Each stacking assembly 18 includes an opening 28 and a stacking tab 30. The first folding panel 84 of the first panel 66 includes at least one opening 28 where once the first panel 66 is assembled and installed in the shipping container 12, the opening 28 is opposite the bottom wall 34 of the shipping container 12.

In various embodiments, the bulkhead system 10 is assembled by folding or rolling the panels 22 to fit the shape of the shipping container 12. As shown in FIGS. 4-11, the bulkhead assembly 14 is assembled by folding the first panel 66 and the second panel 68 towards the first side 78 of the center panel 64. The first folding panel 84, second folding panel 86, and third folding panel 88 of the first panel 66 are folded or rolled into a triangular shape. The assembled first panel 66 is secured into place by at least one locking assembly 16. The flap 24 of the locking assembly 16 is flipped up so that the assembled first panel 66 may fit into the locking tab 26. Together the locking tab 26 and flap 24 secure the first panel 66 being coupled or secured to the second folding panel 86. The second panel 68 is assembled similar to the first panel 66. Once assembled, the opening 28 on the first folding panel 84 of the first panel 66 is opposite the stacking tab 30 on the first folding panel 90 of the second panel 68. Once the bulkhead system 10 is installed in the shipping container 12, the first folding panel 90 of the second panel 68 is flush with the bottom wall 34 of the shipping container 12 and the first folding panel 84 of the first panel 66 is above the second panel 68 along the y-axis 36.

In one embodiment, a first bulkhead system 10 is configured to be coupled to a second bulkhead system 10. When installing multiple bulkhead systems 10 in the shipping container 12, the second bulkhead system 10 may be stacked on top of the first bulkhead system 10. For example, when placing the second bulkhead system 10 on top of the first bulkhead system 10, the stacking tab of the second bulkhead system 10 is configured to fit into the opening of the first bulkhead system 10 creating a flush fit. The opening of the first bulkhead system 10 is configured to receive the stacking tab of the second bulkhead system 10 so that the second bulkhead system 10 is stacked on top of the first bulkhead system 10.

In one embodiment, the first panel 66 and the second panel 68 include angled roll up feature for additional beam strength. The first panel 66 and second panel 68 roll up features are started at a 90° to create a planar top and planar bottom. The angles are then projected to roll at 45°. As shown in the FIGS. 3-11, the angled roll ups on the bulkhead system 10 have special cut/score 96 to reduce assembly implications. It should be appreciated that this feature eases the assembly process by reducing the backlash memory effect from the heavy corrugated structure.

In another embodiment, the bulkhead system 10 includes the flip up flap 24 and the tab 26 locking feature for the roll ups to ease assembly without creating an open hole in the fourth side 62. The bulkhead system 10 includes the scored panels 100, 102 on each end, with the cut out 101 to eliminate obstruction with welded reinforcements in the sides 38, 40 of the shipping container 12. These scored panels 100, 102 seat into a section of the channel 50 on the side walls 38, 40 of the shipping container 12. The angle roll ups fit the contour of the side walls 38, 40 of the shipping container 12. With the scored panels 100, 102 of the bulkhead system 10 seating into the channels 50, the shape of the roll up continues outward/inward to the shipping container 12 to create a tight holding fit. To obtain this wall gripping feature the bulkhead system 10 is slightly wider than the width of the shipping container 12 to create an inward projection/angle affect in the center of the bulkhead system 10. This is to help dissipate the pressure of the material being loaded thus forcing the bulkhead tighter against the side walls 38, 40 of the shipping container 12. It should be appreciated that this feature is both on the first panel 66 and the second panel 68 of the bulkhead system 10.

The present invention has been described in an illustrative manner. It is to be understood that the terminology, which has been used, is intended to be in the nature of words of description rather than of limitation.

Many modifications and variations of the present invention are possible in light of the above teachings. Therefore, the present invention may be practiced other than as specifically described.

What is claimed is:

1. A bulkhead system for securing materials in a shipping container comprising:
a bulkhead assembly comprising a sheet of material having a plurality of panels, wherein each panel includes a plurality of folding panels; and
at least one locking assembly to lock the folding panels together, wherein the at least one locking assembly includes a flap and a locking tab to lock a first folding panel and a second folding panel of the folding panels together, wherein the flap is flipped up so that the first folding panel fits into the locking tab and the locking tab and the flap secures the first folding panel and the second folding panel together.

2. The bulkhead system as set forth in claim 1 wherein the panels comprise a center panel, a first panel, and a second panel.

3. The bulkhead system as set forth in claim 2 wherein the first panel includes the first folding panel, the second folding panel, and a third folding panel.

4. The bulkhead system as set forth in claim 3 wherein the bulkhead assembly is assembled by folding the first panel and the second panel towards a first side of the center panel.

5. The bulkhead system as set forth in claim 4 wherein the first folding panel, the second folding panel, and the third folding panel of the first panel are formed into a triangular shape for an assembled first panel.

6. The bulkhead system as set forth in claim 5 wherein the assembled first panel secured into place by the at least one locking assembly.

7. The bulkhead system as set forth in claim 2 wherein the second panel includes the first folding panel, the second folding panel, and a third folding panel.

8. The bulkhead system as set forth in claim 7 wherein the first panel and the second panel are folded towards a first side of the center panel.

9. The bulkhead system as set forth in claim 8 wherein the first folding panel, the second folding panel, and the third folding panel of the second panel are formed into a triangular shape for an assembled second panel.

10. The bulkhead system as set forth in claim 9 wherein the assembled second panel secured into place by the at least one locking assembly.

11. The bulkhead system as set forth in claim 1 including a stacking assembly having an opening and a stacking tab.

12. The bulkhead system as set forth in claim 11 wherein each of the panels is foldably adjoined to an adjacent panel and each opening is configured to receive the at least one stacking tab.

13. The bulkhead system as set forth in claim 12 wherein the panels are formed into a projection along a y-axis.

14. The bulkhead system as set forth in claim 1 wherein the bulkhead assembly has a width greater than a width of an opening of the shipping container.

15. A bulkhead system for securing materials in a shipping container comprising:
a bulkhead assembly comprising a sheet of material having a plurality of panels, wherein the panels comprise a center panel, a first panel, and a second panel, wherein each of the first panel and the second panel include a first folding panel, a second folding panel, and a third folding panel; and
at least one locking assembly on each of the first panel and second panel to lock the first folding panel and second folding panel together, wherein the at least one locking assembly includes a flap and a locking tab, wherein the flap is flipped up so that the first folding panel fits into the locking tab and the locking tab and the flap secures the first folding panel and the second folding panel together.

16. The bulkhead system as set forth in claim 15 wherein the bulkhead assembly is assembled by folding the first panel and the second panel towards a first side of the center panel, and the first folding panel, the second folding panel, and the third folding panel of the first panel are formed into a triangular shape for an assembled first panel.

17. The bulkhead system as set forth in claim 15 wherein the bulkhead assembly is assembled by folding the first panel and the second panel towards a first side of the center panel, and the first folding panel, the second folding panel, and the third folding panel of the first panel are formed into a triangular shape for an assembled second panel.

18. The bulkhead system as set forth in claim 15 including a stacking assembly having an opening and a stacking tab, wherein each of the panels is foldably adjoined to an adjacent panel and each opening is configured to receive the at least one stacking tab.

19. The bulkhead system as set forth in claim 15 wherein the panels are formed into a projection along a y-axis.

20. The bulkhead system as set forth in claim 15 wherein the sheet of material is made of cardboard.
